(19) United States
(12) Patent Application Publication
(10) Pub. No.: US 2002/0088756 A1
(43) Pub. Date: Jul. 11, 2002

(54) Magnetic cleaning tool

(76) Inventor: Dan L. Wolosion, Richmond, MI (US)

Correspondence Address: BRINKS HOFER GILSON & LIONE, P.O. BOX 10395, CHICAGO, IL, 60610, US

(21) Appl. No.: 09/755,578

(22) Filed: Jan. 5, 2001

(51) Int. Cl. B03C 1/02

(52) U.S. Cl. 210/695; 210/222; 15/1

(57) ABSTRACT

A magnetic cleaning tool having a housing defining a cavity, a plunger partially disposed within the cavity, and a magnet located on the plunger is provided. Withdrawal of the plunger from the cavity moves the magnet along the cavity and thereby removes the magnetic field from one end of the housing. This removal of the magnetic field allows a user to easily detach any particles adhered to the exterior surface of the housing due to the presence of the magnetic field by simply pulling the plunger and moving the magnet. The assembly may also include a peripheral skirt that assures the removal of adhered particles, and straps that facilitate securement of the assembly to another body, such as a tank. A method of using the magnetic cleaning tool to remove metallic fines from lapping compounds is also provided.

### FIELD OF THE INVENTION

The present invention relates generally to a magnetic cleaning tool that can be used in a variety of applications, including the removal of metallic particles from a medium.

### BACKGROUND OF THE INVENTION

Magnets can be used to remove metallic particles from a medium, such as a liquid solution. Frequently, however, it is difficult to remove the particles that become attracted to the magnet due to the magnetic force. The present invention provides a magnetic cleaning tool that generates a magnetic field at one portion of the tool to collect particles, and allows selective movement of the magnetic field to another portion of the tool, thereby allowing a user to easily and readily eject particles attached to the tool due to the magnetic field. The invention also relates to a method of removing metallic particles from a solution by utilizing the magnetic cleaning tool of the present invention.

### BRIEF DESCRIPTION OF THE FIGURES

FIG. 1 is a perspective view, partially broken away, of one embodiment of a magnetic cleaning tool, in accordance with the present invention;

FIG. 2 is a cross sectional view of the magnetic cleaning tool shown in FIG. 1;

FIG. 3 is a perspective view of an alternate embodiment of a magnetic cleaning tool in accordance with the present invention;

FIG. 4 is an elevational view of the magnetic cleaning tool shown in FIG. 3;

FIG. 5 is an exploded perspective view of the magnetic cleaning tool shown in FIG. 3;

FIG. 6 is a perspective view of an alternate embodiment of a magnetic cleaning tool, in accordance with the present invention;

FIG. 7 is a flow diagram of a method of removing metallic particles from a solution using a magnetic cleaning tool of the present invention.

### DETAILED DESCRIPTION OF THE INVENTION

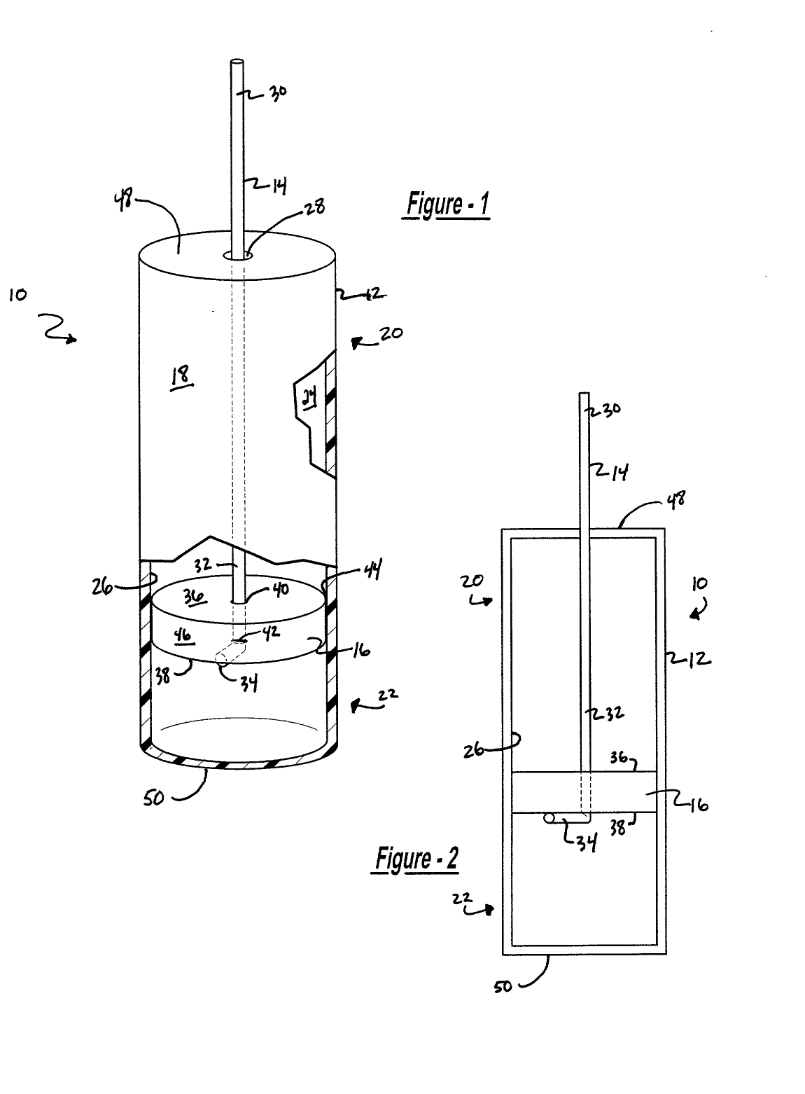

As illustrated in FIG. 1, the invention relates to a magnetic cleaning tool, generally indicated in the figures by reference number 10. The general components of the magnetic cleaning tool 10 include a housing member 12, a plunger 14, and a magnet 16. By moving the plunger 14 along the lengthwise axis of the housing member 12, a user of the magnetic cleaning tool 10 can move the magnet 16 within the housing member 12, thereby changing the position of the magnetic field produced by the magnet 16. This characteristic of the magnetic cleaning tool 10 makes it particularly useful for removing particles, such as metallic fines, that are adhered to the housing member 12 due to the magnetic field produced by the magnet 16.

The housing member 12 is preferably a hollow body, having an exterior surface 18, an upper end 20, and a lower end 22. The housing member 12 serves to separate the magnet 16 and a portion of the plunger 14 from metallic particles being attracted to the magnet 10. The housing member defines an interior cavity 24, bounded by an interior surface 26. The upper end 20 of the housing member 12 preferably defines an aperture 28. The aperture 28 allows communication between the interior cavity 24 and the exterior of the housing member 12. The aperture 28 can be an opening that constitutes the entire upper end 20 of the housing member 12, or may be a relatively small opening. Alternatively, the aperture 28 may constitute a slot on the side of the housing member 12. The only restriction on the aperture 28 is that it must accommodate the plunger 14 such that it can effect upward and downward movement within the housing member 12.

In the preferred embodiment, the housing member 12 is able to trap air or other gas, thereby conferring buoyancy onto the assembly 10. Alternatively, buoyancy can be achieved by placing flotation means, such as Styrofoam or air containing packets, etc., on or in the housing member 12. Also alternatively, the magnetic cleaning tool 10 need not be buoyant at all.

The housing member 12 is preferably an elongate cylindrical member having closed ends 20, 22 except for the aperture 28, and defining an interior cavity 24. However, various configurations can be utilized for the housing member 12 and the exact size and shape of the housing member 12 will depend on the application for which the magnetic cleaning tool 10 is utilized. The preferred elongate cylindrical housing member 12 allows for the use of readily available disc-shaped magnets. If the function requires a different shape, the housing member 12 can be changed accordingly. For example, if the magnetic cleaning tool 10 will be positioned in a corner of a square or rectangle-shaped tank, the housing member 12 can be an elongate member having a square or rectangular cross-sectional shape. This allows the magnetic cleaning tool 10 to be firmly seated in the corner of the tank. For the application of removing metallic fines from tanks containing lapping compounds, an elongate cylindrical plastic tube having an inner diameter of approximately 1.875″ and a length of approximately 6″ has been found suitable for use in tanks commonly used for lapping applications.

The housing member 12 is preferably composed of material compatible with any solution or other matter to which the magnetic cleaning tool 10 may be exposed. Thus, the composition of the housing member 12 can vary and depends on the ultimate use of the magnetic cleaning tool 10. Preferably, the material is plastic and is formed by conventional methods. However, any material suitable for sustained exposure to common liquids and/or gases can be utilized and any suitable method of manufacture may be used to make the housing member 12. Thus polyvinyl chloride and vinyl are suitable materials for the housing member 12.

The plunger 14 preferably is an elongate, wire-like member having a first end 30 and a second end 32. In the magnetic cleaning tool 10, the plunger 14 extends from outside the housing member 12, through the aperture 28, and into the interior cavity 24. That is, the plunger 14 is partially disposed within the interior cavity 24 such that the first end 30 remains out of the housing member 12, and the second end 32 is positioned within the housing member 12. To maintain the closed nature of the housing member 12, a seal such as a gasket or other fitting, may be disposed in the aperture 28 so long as it allows the plunger 14 to move up and down. Alternatively, the aperture 28 may be small enough to provide a compression seal against the plunger 14 while still allowing the plunger 14 to move up and down in the aperture 28.

As best illustrated in FIG. 2, a lower retainer 34 sits below the magnet 16 within the interior cavity 24 of the housing member 12. Preferably, the plunger 14 defines the lower retainer 34, such as by forming a bend or kink in the second end 32 of the plunger 14. Alternative forms can of course be used for the lower retainer 34, such as a loop, curl formation, knot or other disruption in the second end 32 of the plunger 14. Alternatively, the lower retainer 34 can comprise a separate body attached to the second end 32 of the plunger 14. No matter the form, the lower retainer 34, by its shape and location, assures the adjacency of the magnet 16 to the plunger 14.

When the housing member 12 comprises an elongate cylindrical plastic tube having an inner diameter of approximately 1.875″ and a length of 6″, a 10-inch length of #12 gage wire is suitable for use as the plunger 14. This length allows the plunger 14 to form the lower retainer 34 and also allows sufficient length to pass through the aperture 28. In this embodiment, the lower retainer 34 is formed by an approximate ½ inch bend in the second end 32 of the plunger 14, positioned at a 90° angle to the remainder of the plunger 14.

The magnet 16 is seated on the plunger 14 and is retained in this position by the lower retainer 34. The magnet 16 has an upper surface 36 and lower surface 38, and preferably defines a through opening 40. The through opening 40 is a passageway extending from the upper surface 36, through the magnet and to the lower surface 38. Preferably, the through opening 40 is centrally located on the magnet 16. The diameter 42 of the through opening 40 is sufficiently large enough to allow at least the plunger 14 to pass through the through opening 40. However, the diameter 42 of the through opening 40 is small enough to prevent the lower retainer 34 from passing through the through opening 40. This arrangement ensures that the magnet 16 remains seated on the plunger 14.

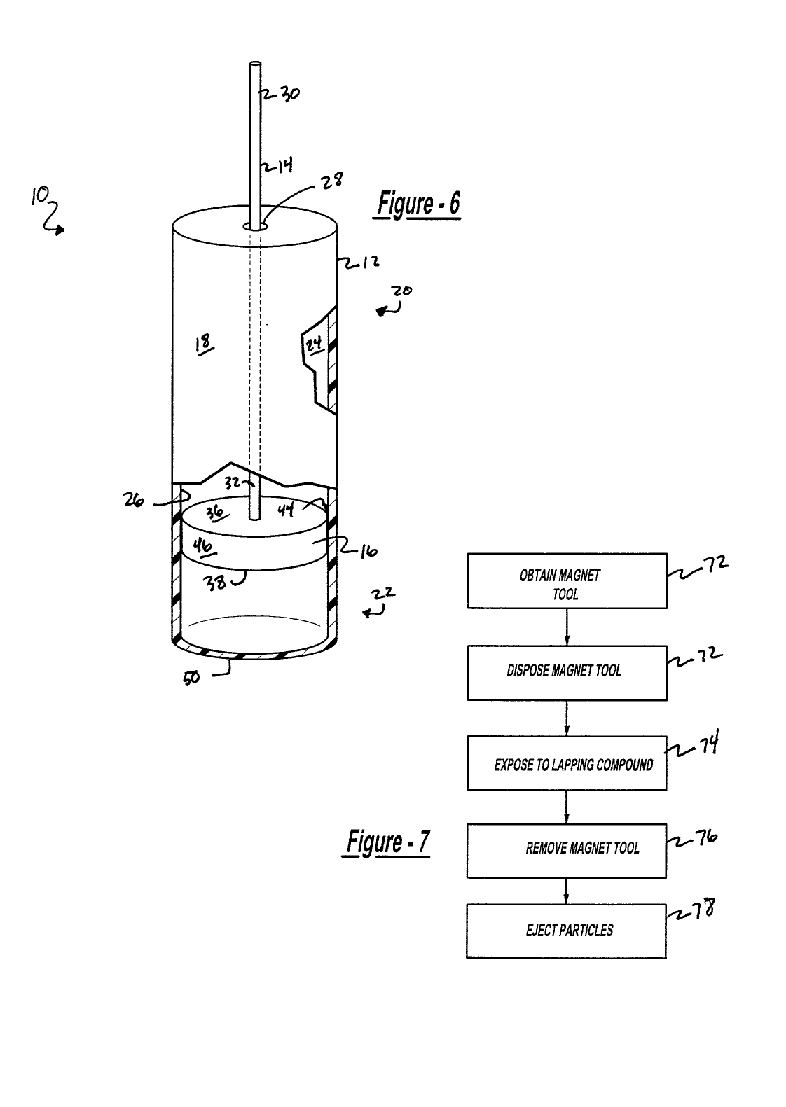

Alternatively, the magnet 16 can comprise a continuous surface, i.e., lack a through opening. As best illustrated in FIG. 6, the magnet 16 can be directly connected to the plunger 14, may be integrally formed by the plunger 14, or may be secured to the plunger 16 in any number of ways, including a weld joint, a hook and loop connection, adhesive, or other suitable means of securement.

The magnet 16 has a shape similar to the cross sectional shape of the housing member 12. Also, the magnet 16 is preferably slightly smaller in size and shape than the cross section of the interior cavity 24 of the housing member 12. This arrangement creates a gap 44 between the perimeter 46 of the magnet 16 and the inner surface 26 of the housing member 12. The gap 44 is preferably large enough to allow the magnet 16 to move freely within the cavity 24 when the plunger 14 is moved axially within the housing member 12, but is not so large as to prevent the magnetic field of the magnet 16 from extending beyond the portion of the housing member 12 near the magnet 16.

When an elongate cylindrical housing member 12 is utilized, the magnet 16 preferably comprises a flat, disc-shaped member having a circular cross sectional shape. This cross sectional shape is similar to the cross sectional shape of the cylindrical housing member 12. In the preferred embodiment, a magnet 16 having a diameter of approximately 1.750″, a height of approximately 0.25″, and a center hole with a diameter of about 0.875″ is acceptable. Also in this embodiment, a gap 42 of approximately 1/16 inch allows free movement of the magnet 16 within the interior cavity 24 without detracting from the magnetic field on the exterior of the housing member 12.

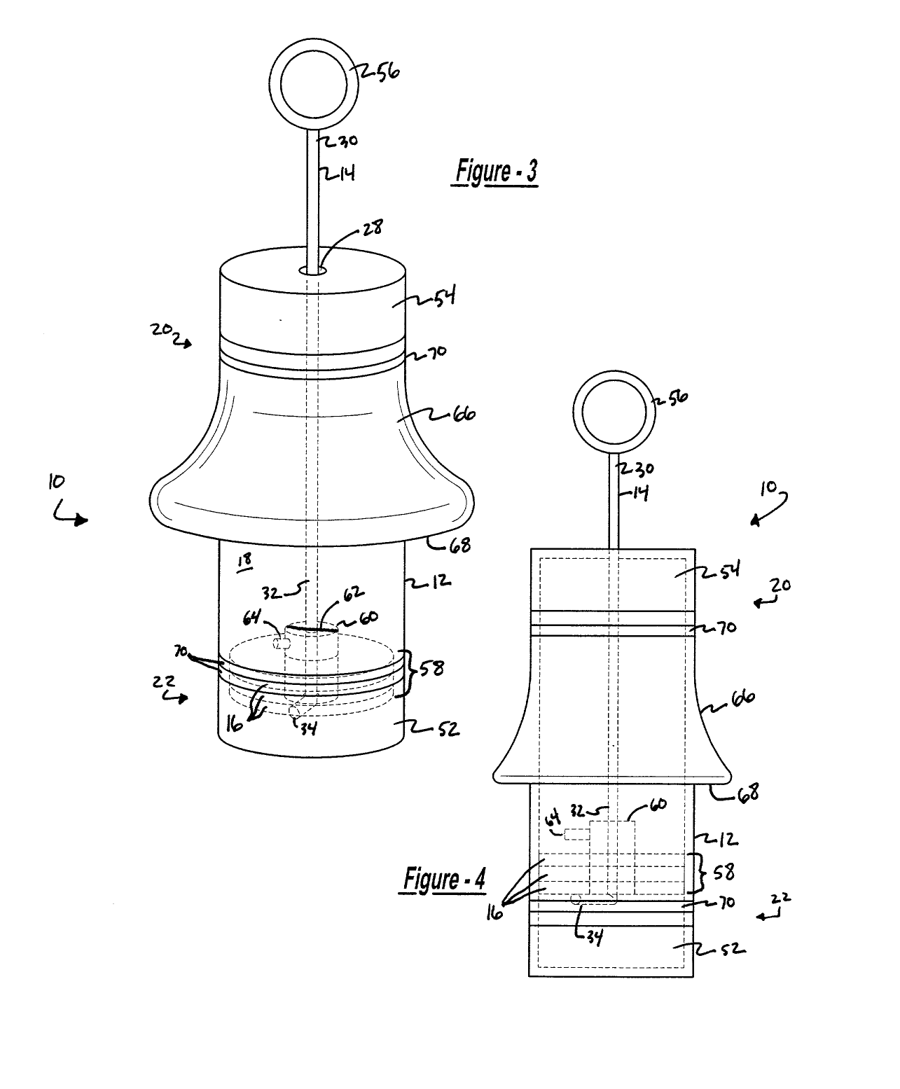

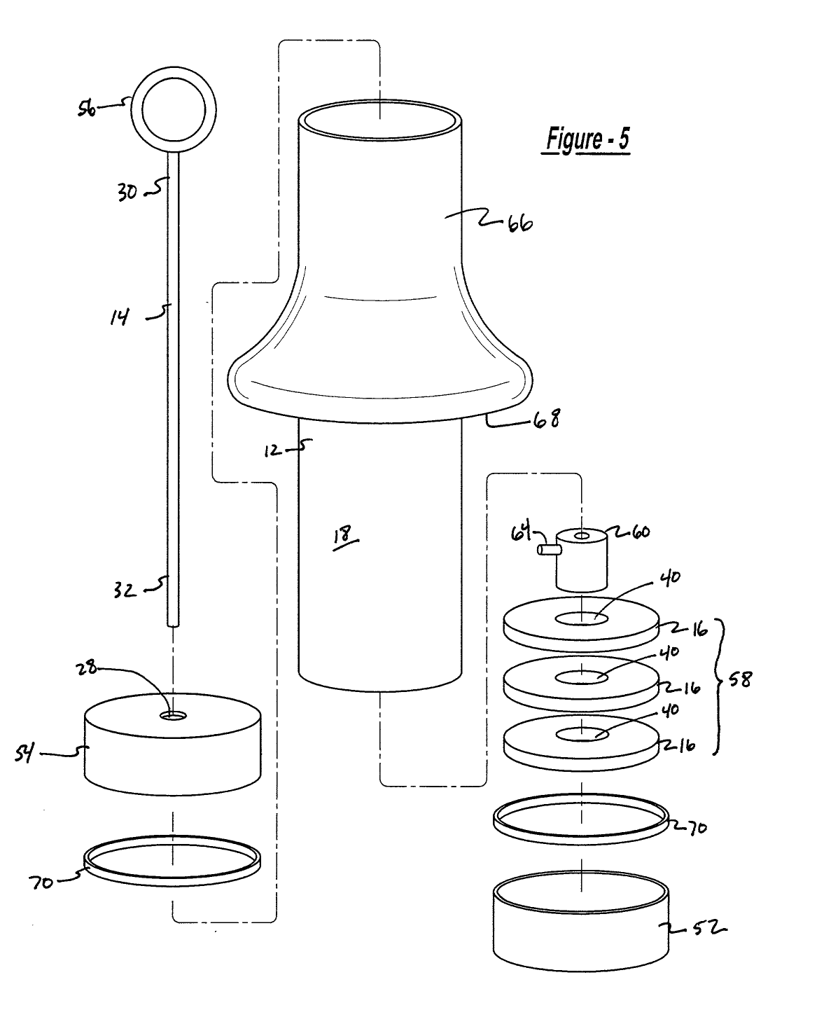

FIGS. 3, 4, and 5 illustrate an alternative embodiment of the magnetic cleaning tool 10 of present invention. In this embodiment, the housing member 12 is an open ended cylindrical body, having an upper opening 48 and a lower opening 50. To allow the magnetic cleaning tool 10 to accomplish the function of removing particles adhered to the surface of the housing member 12 due to the magnetic field of the magnet 16, at least the lower opening 50 of the housing member 12 must be closed. This ensures that particles attracted toward the magnet by its magnetic field will not actually come into contact with the magnet. Thus, in this embodiment, a lower end cap 52 is secured to the lower end 22 of the housing member 12, closing the lower opening 50. It is also preferable to prevent the plunger 14 from moving laterally within the upper opening 48 of the housing member 12 because such movement may disturb the position of the magnet 16. Thus, in this embodiment, an upper end cap 54 is secured to the upper end 20 of the housing member 12 in a fashion similar to that of the lower end cap 52. In this position, the upper end cap 54 defines the aperture 28 for the plunger 14. Similar to the housing member 12, the lower 52 and upper 54 end caps are preferably composed of material compatible with any solution to which the magnetic cleaning tool 10 may be exposed. For use of the magnetic cleaning tool 10 in lapping compounds, vinyl is a suitable material for the lower 52 and upper 54 end caps.

To prevent inadvertent disassembly of the magnetic cleaning tool 10 of this embodiment, both the lower 52 and upper 54 end caps are preferably secured to the housing member 12. For example, an adhesive can be applied between the end caps 52, 54 and the housing member 12. Essentially any adhesive can be used, but adhesives that provide stable and strong bonds during extended exposure to grit-containing compounds, such as those commonly used in lapping procedures, are preferred. Preferably, the adhesive is suitable for use with polyvinyl chloride components. Alternatively, the end caps 52, 54 can comprise a female threaded fastener while the upper 20 and lower 22 ends of the housing member 12 form male threaded fasteners. In this arrangement, the end caps 52, 54 are simply threaded onto the housing member 12. Essentially any means of securement can be utilized. Indeed, even end caps 52, 54 that are simply press fit onto the housing member 12 can be utilized. Preferably, the securement of the end caps 52, 54 to the housing member 12 is such that particles attracted to the magnet are not able to pass through the joint.

The plunger 14 can also define a handle 56 that facilitates the upward and downward movement of the plunger 14. For example, as best illustrated in FIG. 4, the first end 30 of the plunger 14 can be curled into a ring-shape to form a handle 56. This ring-shaped handle 56 allows a user to easily grasp the plunger 14 and move the magnet 16 upward or downward. When a 10-inch length of wire is used for the plunger 14, as indicated above, a ½-inch ring is suitable for the handle 56. The handle 56 can take on any form that facilitates the grasping of the plunger 14 by a human hand or a mechanical tool of any type. Furthermore, the handle 56 can constitute a separate member attached to the plunger 14.

FIG. 4 also illustrates the use of a plurality of magnets 58 in the magnetic cleaning tool 10. A plurality of magnets 58 can be utilized to provide a stronger magnetic field, or even to allow a user to customize the strength of the magnetic field of the magnetic cleaning tool 10 for a particular application. When a plurality of magnets 58 is utilized, the individual magnets are preferably of the same size and shape. Also, the through openings 40 of each magnet in the plurality of magnets 58 must align with each other in a manner that allows the plunger 14 to extend through all of the magnets in the plurality 58. Preferably, the diameters 42 of the through openings 40 of the individual magnets in the plurality 58 are identical. Lastly, when a plurality 58 is used, the individual magnets are preferably situated such that the poles are aligned, i.e., the magnets attract one another rather than repel one another.

When the diameter 42 of the through opening 40 is somewhat larger than that of the plunger 14, a spacer 60 may be utilized to provide a snug fit between the magnet 16 and the plunger 14. The spacer 60 has an opening and the plunger 14 passes through the opening of the spacer 60 in a manner similar to its passage through the magnet 16. The spacer 60 serves to fill the through opening 40 of the magnet 16, thereby stabilizing the magnet 16 of the plunger 14. The spacer 60 can serve to center a magnet 16 on the plunger 14. A wood dowel having a outer diameter of 0.875″ and a 0.125″ center drilled hole is acceptable for use with the plunger 28 and magnet 16 of the preferred embodiment.

An upper retainer 64 may also be present in the magnetic cleaning tool 10. When present, the upper retainer 64 prevents the magnet 16 from moving upward on the plunger 14. Thus, when the upper retainer 64 is present, the upper retainer 64 cooperates with the lower retainer 34 to axially retain the magnet 16 in a fixed position or within a fixed section on the plunger 14. The upper retainer 64 can be defined by the plunger 14, defined by the spacer 60, or can constitute a separate body attached to either the plunger 14 or the spacer 60. For example, the plunger 14 can include a bend or kink in the area immediately above the magnet 16. In this configuration, the bend or kink in the plunger 14 constitutes the upper retainer 64. Alternatively, a separate member may be utilized as the upper retainer 64. For example, an attachment such as a ring can be secured to the plunger 14, or an attachment such as a staple or other protrusion can be secured to the spacer 60, if present.

The magnetic cleaning tool 10 may further include a peripheral skirt 66 disposed about the exterior surface 18 of the housing member 12. The peripheral skirt 66 has a lower surface 68 that is preferably substantially perpendicular to the lengthwise axis of the housing member 12. Preferably, the peripheral skirt 66 is a unitary plastic member with a central opening for the housing member 12. Also preferable, the peripheral skirt 66 is positioned approximately at the midpoint of the lengthwise axis of the housing member 12. The peripheral skirt 66 serves to assure the removal of particles adhered to the housing member 12 due to the magnetic field of the magnet 16 upon operation of the magnetic cleaning tool 10. That is, when the plunger 14 is withdrawn, thereby moving the magnet 16 upward in the interior cavity 24 of the housing member 12, the magnetic field of the magnet 16 moves away from the lower end 22 of the housing member 12. As the magnet 16 moves, any particles adhered to the exterior surface 18 of the housing member 12 will likely move along the exterior surface 18 as the magnet 16 travels upward in the interior cavity 24. When the peripheral skirt 66 is present, the adhered particles are prevented from moving beyond the lower surface 68 of the peripheral skirt 66. Thus, as the magnet 16 moves beyond the location in the interior cavity 24 that corresponds to the location of the peripheral skirt 66 on the exterior surface 18, the lower surface 68 of the peripheral skirt 66 forces the adhered particles to stop traveling along the exterior surface 18, and eventually forces their ejection from the housing member 12 when the magnetic field is too weak to retain them.

The magnetic cleaning tool 10 may further include one or more straps 70. The straps 70 provide a mechanism for securing the magnetic cleaning tool 10 to another structure, such as a tank used in a lapping process. Preferably, the straps 70 are disposed about the exterior surface 18 of the housing member 12 and have a portion available for securing to an object. Tie-wraps or cable ties commonly used in various arts are acceptable for use as the straps 70. In the preferred embodiment, two straps 70 are disposed about the exterior surface 18 of the housing member 12, one located near the upper end 20 and the other located near the lower end 22. The straps 70 can also provide a base for securing another attachment mechanism, such as a cable or hook, to the magnet cleaning tool 10.

As indicated above, the magnetic cleaning tool 10 is particularly well suited for removing metallic fines from lapping compounds.

Lapping compounds frequently comprise a grit, such as carbide, mixed into a heavy oil. These compounds are commonly used for polishing gears and other metal parts, tools and assemblies in various industries, including the automotive industry. During the polishing process, small fragments, or fines, become detached from the metallic parts due to the action of the grit, eventually entering the lapping compound. The fines and other metallic particles, such as chips, may then interfere with the polishing process or the equipment, such as pumps, in the tank utilized for the process. To prevent this interference, magnets are commonly disposed in the tanks holding the lapping compound such that the fines are attracted to the magnets. Unfortunately, it is often difficult to remove the small metallic fines and other metallic particles from the magnet. The magnetic cleaning tool 10 of the present invention provides a magnet tool which makes it relatively easy to release metallic fines from the force of a magnetic field.

A method of using the magnetic cleaning tool 10 to remove metallic fines from lapping compounds will now be described. In this method, any embodiment of the present invention can be utilized. However, due to the additional features of the alternate embodiment, including the presence of a peripheral skirt, it is preferred to use that embodiment.

In a first step 72 of the method, a user obtains a magnetic cleaning tool 10 according to the present invention and disposes the tool 10 in a tank used for lapping of gears or other metallic objects. The assembly 10 can be left free in the tank, or can be secured to the tank or another stationary object by use of the straps 70. In a further step 74, the lapping compound is exposed to the magnetic cleaning tool 10. This may include allowing the lapping compound to flow by or around the magnet cleaning tool 10. During this exposure, any metallic fines that are present in the lapping compound will be attracted to the magnet 16 of the magnetic cleaning tool 10. At this point in the method, the plunger 14 should be fully inserted into the interior cavity 24 such that the magnet 16 is seated at the lower end 22 of the housing member 12. The exposure step should continue for a period of time at least long enough to attract metallic fines or other metallic particles present in the tank to the magnetic cleaning tool 10.

In a further step 76, the magnetic cleaning tool 10 is removed from the tank, thereby stopping the exposure of the lapping compound to the magnetic cleaning tool 10. In a further step 78, the user ejects the attracted particles. To accomplish this, the user grasps the plunger 14 and draws the plunger 14 up the inside of the housing member 12. In this step, the user can grasp the plunger 14 by the handle 56 to facilitate the task. As the plunger 14 is withdrawn, the magnet 16 travels upward in the interior cavity 24 of the housing member 12. As the magnet 16 travels, the magnetic field produced by the magnet 16 will move in a similar manner. Any fines adhered to the exterior surface 18 of the housing member 12 due to the magnetic field of the magnet 16 will travel along the housing member 12 as the magnet 16 moves upward. When the magnet 16 reaches a position in the interior cavity 24 that corresponds to the position on the exterior surface 18 at which the peripheral skirt 66 is located, the metallic fines are prevented from moving further upward along the exterior surface 18 of the housing member 12 due to the lower surface 68 of the peripheral skirt 66. The user continues to pull the plunger up the inside of the housing member 12, thereby removing the magnetic field of the magnet 16 from the area of the peripheral skirt 66. When the magnet 16 is sufficiently away from the peripheral skirt 66, such as when the magnet 16 reaches the top of the interior cavity 24, the fines will fall away from the exterior surface 18 of the housing member 12 due to the lack of the presence of a magnetic field in the area. To prevent the metallic fines from drifting away from the workplace, the user may position the magnetic cleaning tool 10 over a waste chamber prior to withdrawing the plunger 14 from the housing member 12. This allows the metallic fines to be collected into the waste chamber upon operation of the magnetic cleaning tool 10. After ejection of the metallic fines or other attracted particles, the magnetic cleaning tool 10 may be deployed for reuse.

This concludes the method of removing metallic fines from a lapping compound tank by utilizing the magnetic cleaning tool 10 of the present invention.

The foregoing disclosure is the best mode devised by the inventors for practicing the invention. It is apparent, however, that several variations in magnetic cleaning tools in accordance with the present invention may be obvious to one skilled in the art. Inasmuch as the foregoing disclosure is intended to enable one skilled in the pertinent art to practice the instant invention, it should not be construed to be limited thereby, but should be construed to include such aforementioned obvious variations. As such, the present invention should be limited only by the spirit and scope of the following claims.

I claim:

1. A magnetic cleaning tool for attaching particles to a portion of the tool and subsequently removing the particles by operation of the tool, said magnetic cleaning tool, comprising:
a housing member having an exterior surface, upper and lower ends, and defining an interior cavity, and said lower end being enclosed to prevent said particles from entering said cavity;
a plunger having first and second ends, and being partially disposed within said cavity of said housing member; and
a magnet coupled with said second end of said plunger;
wherein said magnet can be slideably moved within said cavity by moving said plunger within said cavity such that the magnetic field of said magnet is moved and said particles are ejected from said tool.

2. A magnetic cleaning tool according to claim 1 wherein said upper end defines an aperture for receiving said plunger, and said first end of said plunger passes through said aperture.

3. A magnetic cleaning tool according to claim 1 further comprising a lower retainer for seating said magnet on said plunger, said lower retainer being disposed on said plunger and underneath said magnet.

4. A magnetic cleaning tool according to claim 3 wherein said lower retainer comprises a bend in said plunger.

5. A magnetic cleaning tool according to claim 1 wherein said housing member is an elongate cylindrical member.

6. A magnetic cleaning tool according to claim 1 wherein said upper and lower ends of said housing member comprise upper and lower end caps secured to said housing.

7. A magnetic cleaning tool according to claim 6 wherein said end caps are secured to said housing with an adhesive suitable for extended submersion in grit-containing compounds.

8. A magnetic cleaning tool according to claim 1 wherein said plunger comprises an elongate wire member.

9. A magnetic cleaning tool according to claim 1 wherein said plunger includes a handle on said first end.

10. A magnetic cleaning tool according to claim 1 further comprising a second magnet adjacent said magnet.

11. A magnetic cleaning tool according to claim 1 wherein said magnet is of a shape similar to a cross sectional shape of said cavity.

12. A magnetic cleaning tool according to claim 1 further comprising a spacer disposed on said second end of said plunger, said spacer having a diameter slightly smaller than that of said opening of said magnet, wherein said magnet is disposed about said spacer.

13. A magnetic cleaning tool according to claim 1 further comprising an upper retainer.

14. A magnetic cleaning tool according to claim 1 further comprising a peripheral skirt disposed about said exterior surface of said housing member.

15. A magnetic cleaning tool, comprising:
an elongate cylindrical housing member having an exterior surface and upper and lower ends and defining an interior cavity;
a first end cap secured to said upper end of said housing member and defining an aperture;
a second end cap secured to said lower end of said housing member;
a plunger having first and second ends, said plunger passing through said aperture such that said second end is disposed within said interior cavity and said second end defining a lower retainer;
a magnet having an opening, said second end of said plunger passing through said opening such that said lower retainer is positioned below said magnet;
a spacer disposed on said plunger and within said opening of said magnet; and
an upper retainer;
wherein said magnet can be slideably moved within said cavity by pulling said plunger through said aperture.

16. A magnetic cleaning tool according to claim 14 wherein said end caps are secured to said housing with an adhesive.

17. A magnetic cleaning tool according to claim 14 wherein said plunger comprises an elongate wire member.

18. A magnetic cleaning tool according to claim 14 wherein said lower retainer comprises a bend in said plunger.

19. A magnetic cleaning tool according to claim 14 wherein said upper retainer comprises a bend in said plunger.

20. A magnetic cleaning tool according to claim 14 wherein said upper retainer comprises a separate member secured to said plunger or said spacer.

21. A magnetic cleaning tool according to claim 14 further comprising a peripheral skirt disposed about said exterior surface of said housing member.

22. A method of removing metallic fines from a lapping compound within a tank, the method comprising the steps of:
obtaining a magnetic cleaning tool comprising a housing member having upper and lower ends and defining an interior cavity, said upper end defining an aperture, a plunger having first and second ends, said plunger passing through said aperture such that said plunger is partially disposed within said interior cavity, a magnet capable of producing a magnetic force and having an opening, said second end of said plunger passing through said opening such that said magnet is disposed about said second end of said plunger;
exposing said lapping compound to said magnetic cleaning tool;
removing said magnetic cleaning tool from said tank;
pulling said plunger of said magnetic cleaning tool, thereby moving said magnet upward within said interior cavity and removing said magnetic force from said lower end of said housing member; and
allowing said metallic fines to fall away from said magnetic cleaning tool.
